(19) United States
(12) Patent Application Publication
(10) Pub. No.: US 2023/0082841 A1
(43) Pub. Date: Mar. 16, 2023

(54) METHODS AND SYSTEMS FOR TITLING AND TRADING ALTERNATIVE RESERVES

(71) Applicant: Maverick Gold (NV) LLC, Grass Valley, CA (US)

(72) Inventor: Randolph Marsh, Grass Valley, CA (US)

(21) Appl. No.: 17/944,397

(22) Filed: Sep. 14, 2022

Related U.S. Application Data
(60) Provisional application No. 63/244,070, filed on Sep. 14, 2021.

(51) Int. Cl. G06Q 40/04; G06Q 20/38; G06Q 20/36; G06Q 20/10; G06Q 50/16; G06Q 40/06; G06Q 40/08

(52) U.S. Cl. CPC G06Q 40/04; G06Q 20/389; G06Q 20/3672; G06Q 20/10; G06Q 50/16; G06Q 40/06; G06Q 40/08; G06Q 2220/00

(57) ABSTRACT

A system for titling and trading alternative reserves of physical commodities of a site is disclosed. Tokens associated with equitable title in unsevered commodities are minted and then traded on a blockchain-based transaction network. This allows access to commodites's value in transaction without disturbing their value in place.

### CROSS-REFERENCE TO RELATED APPLICATIONS

This application claims priority to U.S. Provisional Patent Application Ser. No. 63/244,070, titled “Methods and Systems for Titling and Trading Alternative Reserves” and filed on Sep. 14, 2021; the specification, drawings, and claims thereof are entirely incorporated herein by reference.

### FIELD OF THE DISCLOSURE

This disclosure also relates generally to information and communication technology specially adapted for legal and financial transactions and stores. This disclosure relates generally to data processing systems or methods, specially adapted for administrative, commercial, financial, managerial, supervisory, or forecasting purposes—including, for example: payment architectures, schemes, or protocols; commerce; finance (including banking, exchange, and investment); insurance; systems or methods specially adapted for agriculture, fishing, mining, electricity supply, gas supply, water supply, construction, real-estate services, legal services, handling legal documents; and business processing using cryptography.

### BACKGROUND OF THE INVENTION

Gold-related cryptocurrency tokens currently come in three types: (1) tokenization of bullion that is stored in commercial vaults and redeemable on request; (2) forward-sold gold production; and (3) reserves which are fractionally redeemable for severed gold. And those types each require that some gold be mined from the ground. But there exist mines that are known and have been qualified as having gold which has not been produced because of environmental, social, or technical barriers. So there is a need to monetize such stranded assets to release their value as capital.

The objects, materials, and qualities of our world are valuable—for a variety of values and in a variety of ways. For example, a tree has value. It has ‘value in use’—e.g., as a source of lumber or as a source of pulp for paper. And is also has ‘value in place’—e.g., as a habitat for animals, as a source of fruit, or even as an aesthetic good that is beautiful in its place. Sometimes an object's, material's, or quality's ‘value in place’ derives from the absence of the costs—e.g., economic, social, aesthetic costs—of removing it from its place. Other kinds of ‘value in place’ include a function within an ecosystem or as structure of a geologic system or formation.

The value that commodities have, unsevered from their site, is one kind of “value in place.” In such a situation, value in place reflects the value of leaving the commodities unsevered from the site. Value in place may reflect any of a variety of values—e.g., aesthetic value of a commodity at its site; environmental values of the undisturbed site; or the social values that are disturbed by a production-and-supply chain subject to counterfeiting, organized crime, and human exploitation. Of course, commodities often have other values in addition to their value in place. So a need exists to allow at least some of those other values—e.g., value in use or value in transaction—to remain undisturbed despite the preservation of the commodities' value in place.

For example, gold has value in use because it can be used to make ornaments or electronics. And gold has value in transaction because it can be used as a store of value, a unit of account, and/or a medium of exchange. But gold also has value in place due to the value of leaving the environmental and social order undisturbed by mining. In the prior art, the value in use and the value in transaction of gold could only exist if the gold is severed from the environment, thereby destroying its value in place. So a need exists to allow preservation of the gold's value in place while also facilitating the gold's value in transaction (i.e. as a store of value, a unit of account, and/or a medium of exchange).

### SUMMARY OF THE INVENTION

A method for titling and trading alternative reserves of physical commodities of a site—wherein the commodities are owned by a trust having at least one beneficiary, and wherein the trust holds legal title to the commodities and each beneficiary holds a share of equitable title to the commodities—is disclosed, which, in one embodiment, comprises: determining an assessment of an amount of commodities that are at the site; certificating the assessment; providing a blockchain-based transaction network comprising: at least two user devices, and a token server comprising a processor and a cache wherein the cache is for reducing memory latency and access time; minting a first plurality of tokens, wherein each token is associated with an equitable title to a portion of the assessment, wherein each token is a store of a value of the associated equitable title, and wherein each token is a medium of exchange of the associated equitable title; storing each token on a user device; and transferring at least one token from a first user device to a second user device, wherein transferring the token effects a transfer of the associated equitable title.

A system for titling and trading alternative reserves of physical commodities of a site—wherein the commodities are owned by a trust having at least one beneficiary, and wherein the trust holds legal title to the commodities and each beneficiary holds a share of equitable title to the commodities—is disclosed, which, in one embodiment, comprises: a blockchain-based transaction network comprising: a token server comprising a processor and a cache wherein the cache is for reducing memory latency and access time, and at least two user devices, wherein each user device is communicatively coupled to the token server, and wherein each user device is capable of being communicatively coupled to each other user device; a record of a certificated assessment of an amount of commodities that are at the site, wherein the record is stored on the token server; a first plurality of tokens, wherein each token is minted by the token server, wherein each token is associated with an equitable title to a portion of the assessment, wherein each token is a store of a value of the associated equitable title, wherein each token is a medium of exchange of the associated equitable title, and wherein each token is capable of being stored on a user device; wherein at least one token may be transferred from a first user device to a second user device by a communicative coupling between the first user device and the second user device, wherein transferring the token effects a transfer of the associated equitable title.

The above summary presents a simplified summary to provide a basic understanding of some aspects of the claimed subject matter. This summary is not an extensive overview. It is not intended to identify key or critical elements or to delineate the scope of the claimed subject matter. Its sole purpose is to present some concepts in a simplified form as a prelude to the more detailed description that is presented later.

### BRIEF DESCRIPTION OF DRAWINGS

The following drawings are attached to—and form a portion of—this disclosure:

FIG. 1 is a schematic diagram of a site with commodities.

FIG. 2 is a schematic diagram of commodities held in a trust.

FIG. 3 is a schematic diagram of an embodiment of a system for titling and transferring tokens associated with equitable title.

FIG. 4 is a schematic diagram of an embodiment of a system for titling and transferring tokens associated with equitable title.

FIG. 5 is a schematic diagram of an embodiment of a system for titling and transferring tokens associated with equitable title.

FIG. 6 is a flowchart for an embodiment of a method of titling and transferring tokens associated with equitable title.

FIG. 7 is a flowchart for an embodiment of a method of titling and transferring tokens associated with equitable title.

FIG. 8 is a schematic diagram of an embodiment of an existence signal.

### DEFINITIONS

Unless otherwise defined, all terms (including technical and scientific terms) in this disclosure have the same meaning as commonly understood by one of ordinary skill in the art of this disclosure. It will be further understood that terms, such as those defined in commonly used dictionaries, should be interpreted as having a meaning that is consistent with their meaning in the context of the specification and should not be interpreted in an idealized or overly formal sense unless expressly defined otherwise in this disclosure. For brevity or clarity, well known functions or constructions may not be described in detail.

The terms “about” and “approximately” shall generally mean an acceptable degree of error or variation for the quantity measured in light of the nature or precision of the measurements. Typical, exemplary degrees of error or variation are within 20 percent (%), preferably within 10%, more preferably within 5%, of a given value or range of values. Numerical quantities given in this description are approximate unless stated otherwise, meaning that the term “about” or “approximately” can be inferred when not expressly stated.

The terminology used throughout the disclosure is for the purpose of describing particular embodiments only and is not intended to be limiting. The singular forms “a,” “an,” and “the” are intended to include the plural forms as well, unless the context clearly indicates otherwise.

The terms “first,” “second,” and the like are used to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the disclosure. Likewise, terms like “top” and “bottom”; “front” and “back”; and “left” and “right” are used to distinguish certain features or elements from each other, but it is expressly contemplated that a top could be a bottom, and vice versa.

The term “consisting essentially of” means that, in addition to the recited elements, what is claimed may also contain other elements (steps, structures, ingredients, components, etc.) that do not adversely affect the operability of what is claimed for its intended purpose as stated in this disclosure. This term excludes such other elements that adversely affect the operability of what is claimed for its intended purpose as stated in this disclosure, even if such other elements might enhance the operability of what is claimed for some other purpose.

The terms “connected to,” “in connection with,” “in communication with,” or “connecting” include any suitable connection or communication, including mechanical connection, electrical connection (e.g.: one or more wires), or signal-conducting channel (e.g., BLUETOOTH, near-field communication (NFC), or other inductive coupling or radio-frequency (RF) link).

The term “processor” may include one or more processors having processing capability necessary to perform the processing functions described herein, including but not limited to hardware logic, computer readable instructions running on a processor, or any suitable combination thereof. A processor may run software to perform the operations described herein, including software accessed in machine readable form on a tangible non-transitory computer readable storage medium, as well as software that describes the configuration of hardware such as hardware description language (HDL) software used for designing chips.

The term “computer” may include a uniprocessor or multiprocessor machine, in the form of a desktop, laptop, remote server, tablet computer, smartphone, or other computing device. Accordingly, a computer may include one or more processors. Examples of processors include sequential state machines, microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), gated logic, and other suitable hardware configured to perform the various functionality described throughout this disclosure.

Additionally, a computer may include one or more memories. A memory may include a memory storage device or an addressable storage medium which may include, by way of example, random access memory (RAM), static random access memory (SRAM), dynamic random access memory (DRAM), electronically erasable programmable read-only memory (EEPROM), programmable read-only memory (PROM), erasable programmable read-only memory (EPROM), hard disks, floppy disks, laser disk players, digital video disks, compact disks, video tapes, audio tapes, magnetic recording tracks, magnetic tunnel junction (MTJ) memory, optical memory storage, quantum mechanical storage, electronic networks, and/or other devices or technologies used to store electronic content such as programs and data.

In particular, such one or more memories may store computer executable instructions that, when executed by the one or more processors, cause the one or more processors to implement the procedures and techniques described herein. The one or more processors may be operably associated with the one or more memories so that the computer executable instructions can be provided to the one or more processors for execution. For example, the one or more processors may be operably associated to the one or more memories through one or more buses. Furthermore, the computer may possess or may be operably associated with input devices (e.g., a keyboard, a keypad, controller, a mouse, a microphone, a touch screen, a sensor) and output devices such as (e.g., a computer screen, printer, or a speaker).

A computer may execute an appropriate operating system such as LINUX, UNIX, MICROSOFT WINDOWS, APPLE MACOS, IBM OS/2, ANDROID, and PALM OS, and/or the like. A computer may advantageously be equipped with a network communication device such as a network interface card, a modem, or other network connection device suitable for connecting to one or more networks.

A computer may advantageously contain control logic, or program logic, or other substrate configuration representing data and instructions, which cause the computer to operate in a specific and predefined manner as, described herein. In particular, the computer programs, when executed, enable a control processor to perform and/or cause the performance of features of the present disclosure. The control logic may advantageously be implemented as one or more modules. The modules may advantageously be configured to reside on the computer memory and execute on the one or more processors. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro-code, circuitry, data, and the like.

A control logic conventionally includes the manipulation of digital bits by the processor and the maintenance of these bits within memory storage devices resident in one or more of the memory storage devices. Such memory storage devices may impose a physical organization upon the collection of stored data bits, which are generally stored by specific electrical or magnetic storage cells.

A control logic generally performs a sequence of computer-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, files, or the like. It should be kept in mind, however, that these and some other terms should be associated with appropriate physical quantities for computer operations, and that these terms are merely conventional labels applied to physical quantities that exist within and during operation of the computer based on designed relationships between these physical quantities and the symbolic values they represent.

It should be understood that manipulations within a computer are often referred to in terms of adding, comparing, moving, searching, or the like, which are often associated with manual operations performed by a human operator. It is to be understood that no involvement of the human operator may be necessary, or even desirable. The operations described herein are machine operations performed in conjunction with the human operator or user that interacts with the computer or computers.

It should also be understood that the programs, modules, processes, methods, and the like, described herein are but an exemplary implementation and are not related, or limited, to any particular computer, apparatus, or computer language. Rather, various types of general-purpose computing machines or devices may be used with programs constructed in accordance with some of the teachings described herein. In some embodiments, very specific computing machines, with specific functionality, may be required. Similarly, it may prove advantageous to construct a specialized apparatus to perform the method steps described herein by way of dedicated computer systems with hard-wired logic or programs stored in nonvolatile memory, such as, by way of example, read-only memory (ROM).

In some embodiments, features of computers can be implemented primarily in hardware using, for example, hardware components such as application specific integrated circuits (ASICs) or field-programmable gated arrays (FPGAs). Implementation of the hardware circuitry will be apparent to persons skilled in the relevant art(s). In yet another embodiment, features of computers can be implemented using a combination of both general-purpose hardware and software.

The term “signal” means any suitable signal, for example a voltage, a current, a duty cycle, a frequency of electrical oscillation, or a mechanical signal (e.g., pressure, vibration, a tap, or other mechanical signal) in some embodiments.

It is to be understood that any given elements of the disclosed embodiments of the invention may be embodied in a single structure, a single step, a single substance, or the like. Similarly, a given element of the disclosed embodiment may be embodied in multiple structures, steps, substances, or the like.

The following description illustrates and describes the processes, machines, manufactures, compositions of matter, and other teachings of the present disclosure. The disclosure shows and describes only certain embodiments of the processes, machines, manufactures, compositions of matter, and other teachings disclosed; but as mentioned above, it is to be understood that the teachings of the present disclosure are capable of use in various other combinations, modifications, and environments and are capable of changes or modifications within the scope of the teachings of this disclosure, commensurate with the skill and knowledge of a person having ordinary skill in the relevant art. The embodiments described are further intended to explain certain best modes known of practicing the processes, machines, manufactures, compositions of matter, and other teachings of the disclosure and to enable others skilled in the art to utilize the teachings of the disclosure in such, or other, embodiments and with the various modifications required by the particular applications or uses. Accordingly, the processes, machines, manufactures, compositions of matter, and other teachings of the present disclosure are not intended to limit the exact embodiments and examples disclosed herein. Any section headings herein are provided only for consistency with the suggestions of 37 C.F.R. § 1.77 or otherwise to provide organizational cues. These headings shall not limit or characterize the invention(s) set forth herein.

### DETAILED DESCRIPTION

Systems and methods for titling and trading alternative reserves have been developed. Embodiments of the systems and methods are described herein. The embodiments are particularly advantageous for use with metal deposits and distributed-ledger-technology (“DLT”) based or blockchain-based transaction networks. But similar advantages may be enjoyed with other commodities and other transaction networks. The specific type of commodity and transaction network is not important, and embodiments of the invention are agnostic as to the specific type of commodity and transaction network used.

In addition to the description herein and in the accompanying drawings, additional detail is contained in U.S. Provisional Patent Application Ser. No. 63/244,070—titled “Methods and Systems for Titling and Trading Alternative Reserves” and filed on Sep. 14, 2021—which is hereby incorporated by reference into the specification in its entirety.

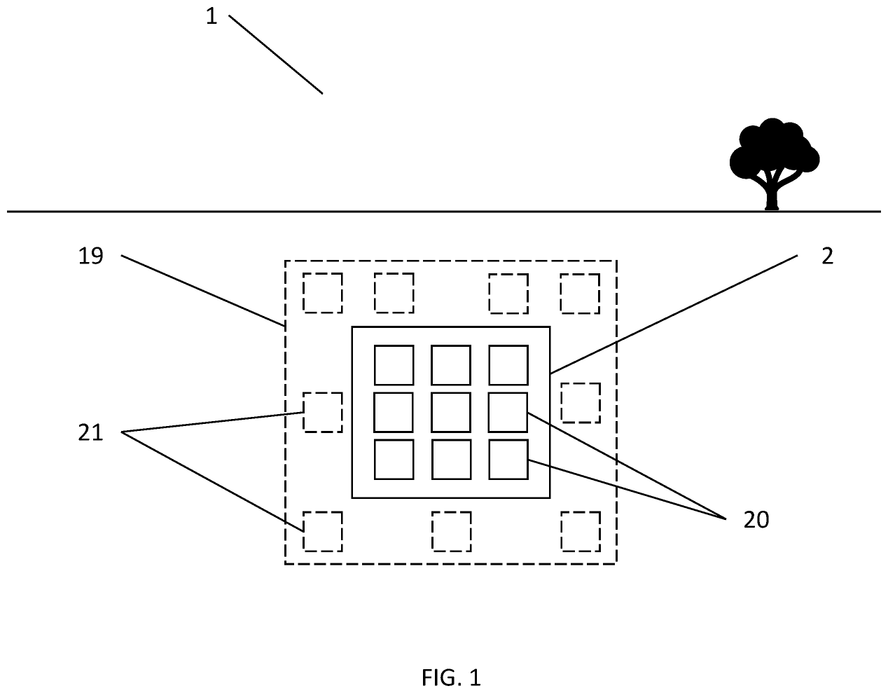

FIG. 1 is a schematic diagram of a site 1 with commodities 2. The site 1 is a physical location, for example a parcel of land. The commodities 2 are any suitable commodities. In some embodiments, the commodities 2 are deposits of one or more of the following: gold, silver, nickel, platinum, palladium, copper, oil, or gas. The commodities 2 shown in FIG. 1 are subsurface commodities. The commodities 2 are unsevered from the site 1. “Unsevered” means, in the case of metal deposits, not mined from the site 1. If the commodities 2 are timber or crops, then “unsevered” means not harvested. In some environments, the commodities are or include qualities of natural items and systems (e.g., the ability of an aquifer to recharge, the cleanness of the air, or the functioning of a rainforest ecosystem). In some environments, the commodities are or include aesthetic qualities such as an unobstructed view or a quality of quietness.

The value that such commodities have, unsevered from the site, is termed “value in place.” Value in place reflects the value of leaving the commodities 2 unsevered from a site 1. Value in place may reflect any of a variety of values—e.g., aesthetic value of a commodity at its site; the aesthetic value of a site unmarred by the removal of a commodity; environmental values of the undisturbed site; or the social values that are disturbed by the production operation and/or production-and-supply chain subject to counterfeiting, organized crime, and human exploitation. Other values reflected by a commodity's 2 value in place include its uses at the site 1—e.g., as a habitat; as housing; as land for forestry, agricultural, pasturing, or grazing; or as a natural water filter or aquifer. Unsevered commodities having value in place are termed “alternative reserves.” Some alternative reserves are specifically SEC-qualified alternative reserves. Wherever this disclosure uses the term “commodities,” “reserves,” or “deposits,” the meaning includes alternative reserves and SEC-qualified alternative reserves as particular cases. Such alternative reserves often have other values in addition to their value in place. In some embodiments of the present invention, those other values—value in use or value in transaction—are undisturbed despite the preservation of the commodities' value in place. For example, gold has value in use because it can be used to make ornaments or electronics. Gold also has value in transaction because it can be used as a store of value, a unit of account, and/or a medium of exchange. But gold also has value in place due to the value of leaving the environmental and social order undisturbed by mining. In the prior art, the value in use and the value in transaction of gold could only exist if the gold is severed from the environment, thereby destroying its value in place. Some embodiments of the present invention allow preservation of the gold's value in place while also facilitating the gold's value in transaction (i.e. as a store of value, a unit of account, and/or a medium of exchange). (In fact, because known methods of production, storage, and transaction are subject to losses and inefficiencies, by facilitating the value in transaction without such losses, the present invention preserves more of the value in transaction than do known methods of production. Further, such known methods are also subject to illicit mining, counterfeiting, organized crime, and human exploitation.)

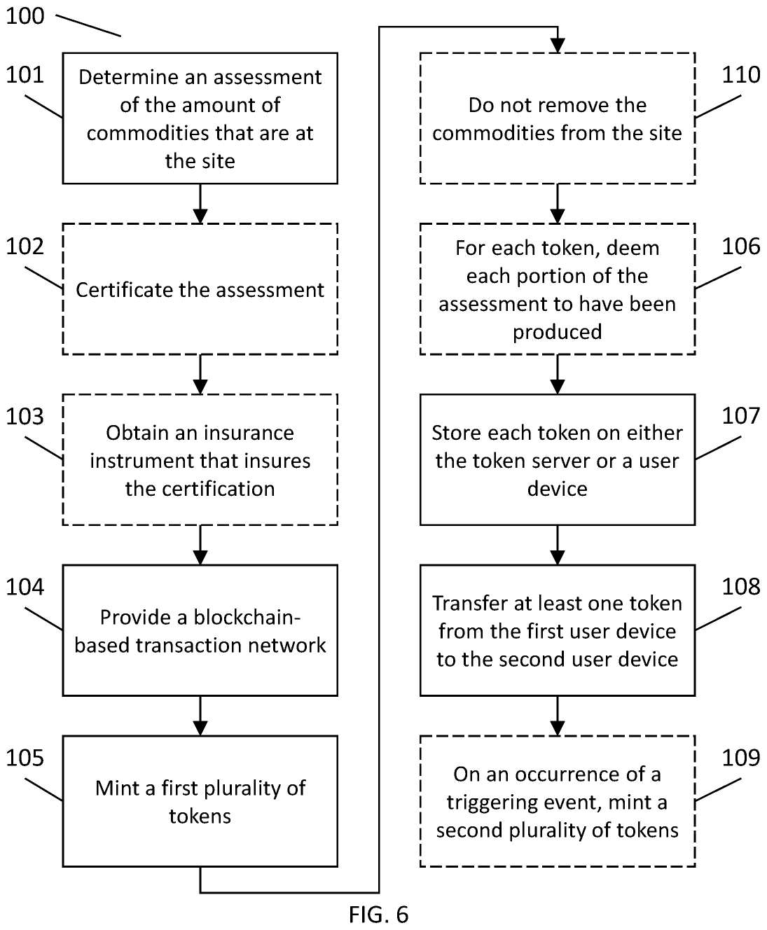

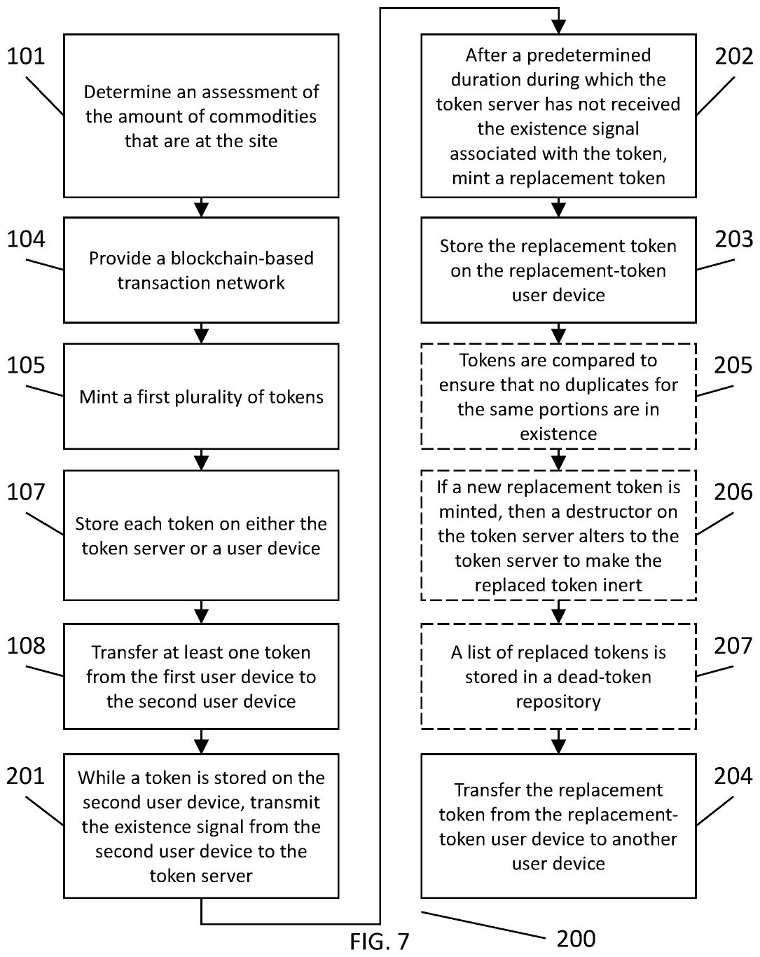

It is possible to assess (e.g., measure or estimate) the amount of commodities 2 at a site 1. The assessing process may include third-party validations and/or recorded attestations. Some methods for assessing the amount of commodities 2 at a site 1 are known. Some such methods are used by publicly-traded mining companies to state their reserve base; the value of publicly-traded mining companies can be affected by the amount of reserve base that they state, so the science of geological assessment is quite mature. The resulting assessment 19 is associated with the commodities 2. The assessment 19 is a certificated assessment, as is described in detail below, especially with respect to FIGS. 6-7.

In some embodiments, the site 1 may be a site from which some commodities were previously removed or damaged. In such an embodiment, the commodities 2 are commodities that remain at the site 1 after the other commodities were previously removed. For example, the site 1 may be a site from which gold was previously mined; nonetheless there usually will still be some gold at the site 1; when the systems and methods of this disclosure are used at a such a site 1, then the commodities 2 are the gold that was not previously mined—due, for example, to unprofitability, to economics, to inefficient mining methods, to environmental or political disruption, or to other business failure unrelated to the commodity resource. The systems and methods of this disclosure may be advantageously used at such a site, especially because previous commodity-removal efforts might have resulted in documented and validated assessment of the commodities 2 at the site 1.

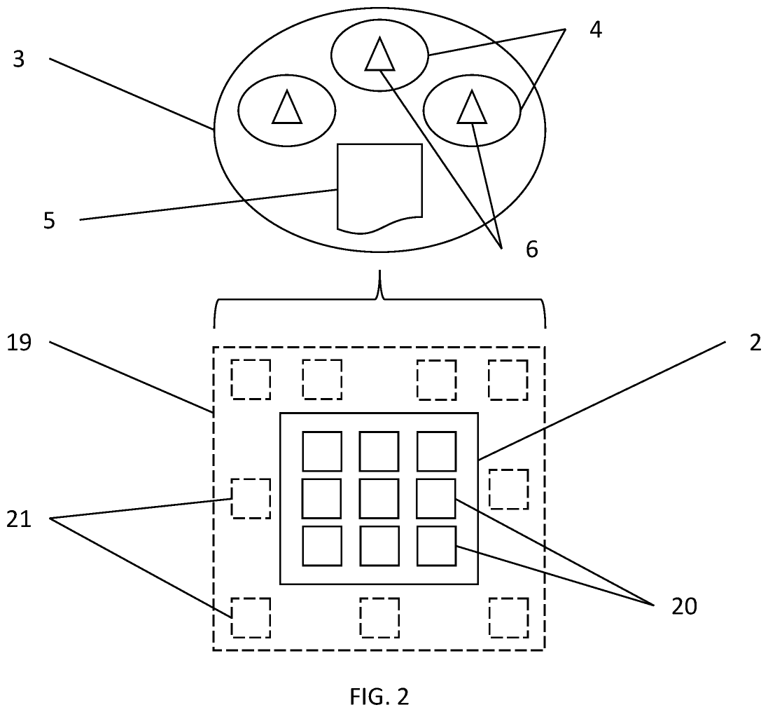

FIG. 2 is a schematic diagram of commodities 2 held by a trust 3. The trust 3 has at least one beneficiary 4. The trust 3 is a legal relationship in which the legal title 5 to the commodities 2 is entrusted to a person or legal entity with a fiduciary duty to hold and use it for the benefit of the beneficiaries 4. The trust 3 is one of the following: an equity real estate investment trust (“REIT”); a mortgage REIT; a statutory trust; or any suitable trust. A variety of trusts is described in Ronald Chester et al., Bogert's The Law of Trusts and Trustees (2021 Westlaw), the entire contents of which are hereby incorporated by reference. One leading example of a statutory trust is a Delaware statutory trust (or “unincorporated business trust”), such as an entity defined in the Delaware Statutory Trust Act, Del. Code Ann. tit. 12, §§ 3801-29 (Jun. 23, 2021). Other jurisdictions with statutes creating trusts include the State of Texas, the Republic of Singapore, the Commonwealth of The Bahamas, the Emirate of Dubai (and other emirates in the United Arab Emirates).

In short, FIG. 2 shows a trust 3 holding legal title 5 to the commodities 2 and having at least one beneficiary 4. FIG. 2 also shows the trust 3 holding legal title to the assessment 19. Each beneficiary 4 holds equitable title 6 to a portion 20 of the commodities 3 and to an associated pro rata portion 21 of the assessment 19. Other and more complex relationships of trusts, beneficiaries, and title are possible without disturbing the systems and methods described herein. For example, in some embodiments, legal title to the assessment may be held by a different entity, for example an “alternative reserve mint” or other such entity. Many variations of ownership of the legal title are possible, as will be understood by one of skill in the art from the following, especially from the descriptions below of the transfer of tokens and of equitable title.

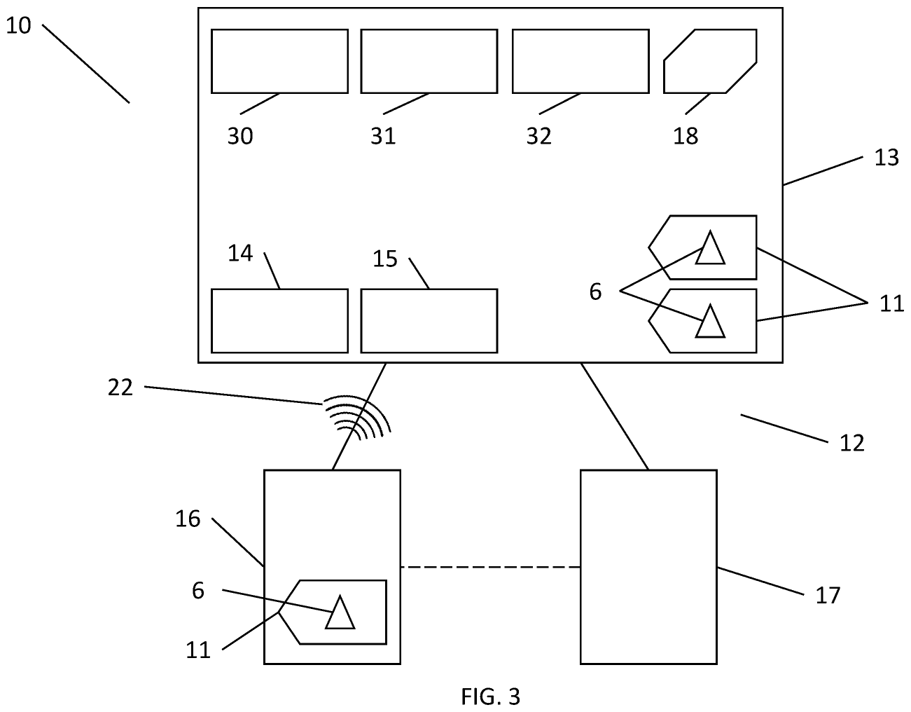

FIG. 3 is a schematic diagram of an embodiment of a system 10 for titling and transferring tokens 11 associated with equitable title 6. The system 10 comprises a blockchain-based transaction network 12. Some embodiments of a blockchain-based transaction network 12 are described in at least: U.S. Pat. No. 10,909,509 to Kurani and titled “Infrastructure for Maintaining Math-Based Currency Accounts”; U.S. Pat. No. 9,898,782 to Winklevoss et al. and titled “Systems, Methods, and Program Products for Operating Exchange Traded Products Holding Digital Math-Based Assets”; U.S. Pat. No. 10,026,082 to Davis and titled “Method and System for Linkage of Blockchain-Based Assets to Fiat Currency Accounts”; and U.S. Pat. No. 11,055,677 to Anderson et al. and titled “Stablecoin as a Medium of Exchange on a Blockchain-Based Transaction Network”—the entire contents of each of which are hereby incorporated by reference. In this disclosure, the term “blockchain-based transaction network” includes distributed-ledger technologies where transactions are recorded with an immutable cryptographic signature; however, the term is not limited to such transaction networks; instead, the term includes distributed-ledger technologies generally—included as described, for example, in U.S. Pat. No. 10,951,697 to Brock et al. and titled “HOLOCHAIN—A Framework for Distributed Applications.” The inventions of this disclosure could be ported to any suitable blockchain-based transaction network.

The blockchain-based transaction network 12 comprises a token server 13 having a processor 14 and a cache 15 (wherein the cache is for reducing memory latency and access time). The token server 13 is adapted to mint tokens (e.g., a first plurality of tokens 11). FIG. 3 depicts the token server 13 as a static, single server. In other embodiments, the token server 13 is a plurality of distributed machines that sign themselves in and out of ‘server’ status as the system 10 needs them. (In such an embodiment, the distributed ledger can contribute to the system's resilience.)

The blockchain-based transaction network 12 also comprises at least two user devices 16, 17. Each user device 16, 17 is communicatively coupled to the token server 13. Further, each user device 16, 17 is capable of being removably communicatively coupled to each other user device 16, 17. A user device 16, 17 is either a physical device or a logical device.

The system 10 comprises a record 18 of a certificated assessment 19 of an amount of commodities 2 that are at the site 1. (Such a certificated assessment 19 is disclosed in detail below, especially with respect to FIGS. 6-7.) The record 18 is stored on the token server 13. In other embodiments, the record 18 may be stored on another server or in any suitable digital or analog format. In some embodiments, the record 18 is stored in a distributed way on each token 11 (described in detail in the following).

The system 10 comprises a first plurality of tokens 11. Each token 11 functions as a title instrument in the form of a cryptocurrency or digital token that allows transfer of ownership of commodities 2 and which functions as a stablecoin tied to the market value of the commodities 2. Each token 11 is a digital token created and recorded on a decentralized ledger. Each token 11 is denominated in units corresponding to a specific amount of commodities (e.g., a specific weight of gold of a standard quality). The value of each quantity of commodities reserves transferred into the digital token is established using conventional methods for measurement, evaluation, and certification of reserves. Each token 11 is a digital token which is created or minted in a process wherein physical reserves are allocated and ownership of said reserves is transferred to the token 11. Subsequently, as described in detail below (especially with reference to FIGS. 6-7) each token 11 may be freely transferred to purchasers via financial transactions.

The systems and methods described herein are independent of any particular digital delivery vehicle. But as a concrete example, a digital token can be created to operate on the Ethereum blockchain using the ERC-20 standard protocol. Other blockchains or distributed-ledger technologies can be utilized for digital token issuance such as: (1) the BEP-2 standard for issuance of tokens on the BINANCE CHAIN; or (2) HOLOCHAIN. The tokens 11 can be implemented on a given blockchain and subsequently traded and their ownership recorded on different blockchains utilizing cross-chain utilities. In some embodiments, a static vault of the proof documents (records, insurance, certifications) can be deposited online and a fingerprint of those validation documents be included with any token instance; then, if the fingerprint included does not match the document repository in the vault, the token is invalidated (or suffers some other compromise of its value or utility).

Each token 11 is minted by the token server 13 such that: each token 11 is associated with an equitable title 6; each token 11 is a store of value of the equitable title 6; each token 11 is a medium of exchange of the equitable title 6; and each token 11 is a unit of account of the equitable title 6. The first plurality of tokens 11 collectively represents equitable title to less than all of the commodities 2 and assessment 19. In other embodiments, the first plurality of tokens 11 collectively represents equitable title to substantially all of the commodities 2 and assessment 19.

In some embodiments, tokens 11 are compared to ensure that no duplicates for the same portion 20 of the commodities or portion 21 of the assessment is in existence. (In some embodiments, the comparison is facilitated by the existence signal 22 and a duplicate checker 30 on the token server 13.) In such embodiments, this check might impair counterfeiting opportunities, thus increasing the reliability and trustworthiness of the systems and methods disclosed herein. In some embodiments, a destructor 31 and/or dead-token repository 32 may contribute similar qualities, as described in detail below, especially with reference to FIG. 7.

Each token 11 is capable of being stored on either the token server 13 or a user device 16, 17. FIG. 3 shows a token 11 stored on a first user device 16. Each user device 16, 17 is adapted to be capable of transmitting an existence signal 22 to the token server 13 when a token 11 is stored on the user device. The existence signal 22 is uniquely associated with the individual token 11. FIG. 3 shows that the first user device 16 is transmitting an existence signal 22 associated with the individual token 11 stored thereon. If multiple tokens were being stored on the first user device 16, then it would send equally multiple existence signals—one for each token stored thereon.

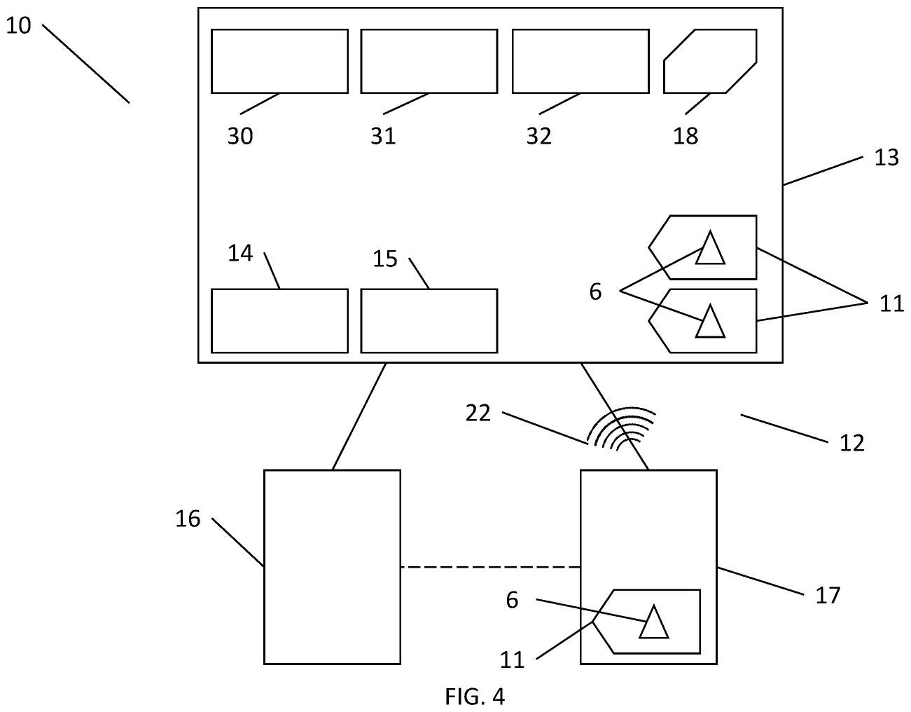

FIG. 4 is a schematic diagram of an embodiment of a system 10 for titling and transferring tokens 11 associated with equitable title 6. Each token 11 is capable of being transferred from a user device (e.g., the first user device 16) to the token server 13 or to another user device (e.g., the second user device 17)—and vice versa. FIG. 4 shows the token 11, that had been stored on the first user device 16, having been transferred—via a communicative coupling—to be stored on the second user device 17. Transferring the token 11 also causes (or “accomplishes” or “effects”) a transfer of the associated equitable title 6. FIG. 4 shows the second user device 17 transmitting to the token server 13 the existence signal 22 associated with the token 11. (That is to say: initially, while the token 11 was stored on the first user device 16, the owner of the first user device 16 was a beneficiary 4 of the trust 3 because of its equitable title 6 to part of the commodities 2 and assessment 19 to which the trust 3 holds legal title 5; then, when the token 11 was transferred to be stored on the second user device 17, the owner of the second user device 17 became a beneficiary 4 instead.)

In some embodiments, the system 10 is adapted to respond to a token-specific, user-specific, and/or owner-specific security key to allow and facilitate forced transfers of tokens 11. Such forced transfers are initiated by governmental entities, courts, creditors, or business contracts (e.g., under a smart contract). There may also be a mechanism whereby this security key is stored with a third-party trustee (e.g., a bank or professional trustee organization for a small fee).

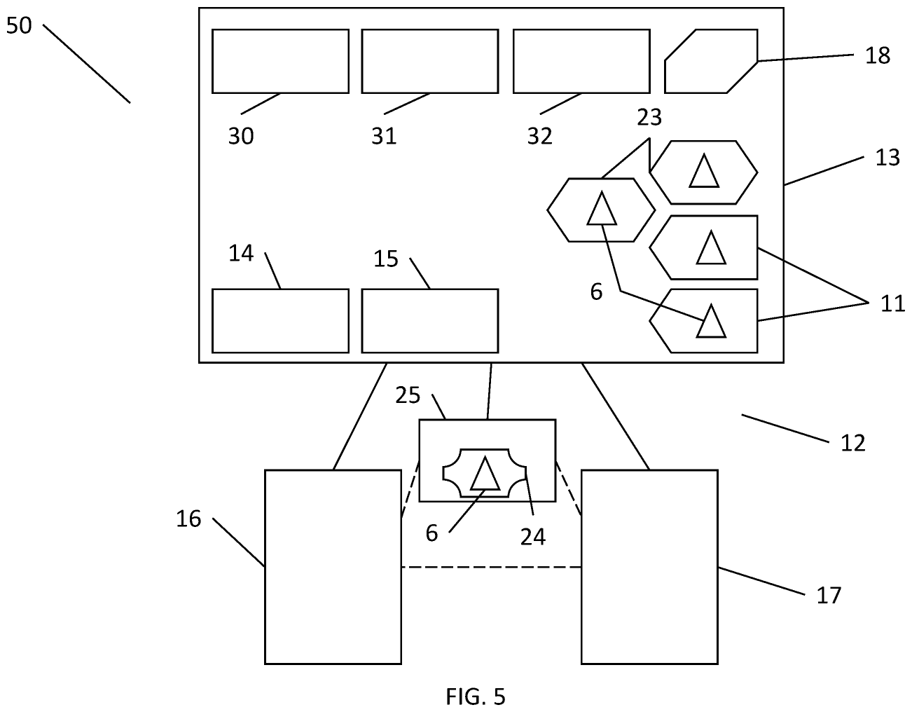

FIG. 5 is a schematic diagram of an embodiment of a system 50 for titling and transferring tokens 11,23 associated with equitable title 6. In this embodiment, the token server 13 is adapted to mint a second plurality of tokens 23. The second plurality of tokens 23 collectively represents equitable title to some part of the commodities 2 and assessment 19, equitable title to which is not represented in the first plurality of tokens 11.

Under normal circumstances, a token 11 exists forever and never expires. But in some circumstances, a token 11 might become lost, damaged, invalidated, or corrupted. (Also, for cross-chain functionality, it might be necessary to burn a token 11 so that it can be minted anew on another blockchain-based transaction network.) The token server 13 is also adapted to mint one or more replacement tokens 24. Tokens of the first plurality of tokens 11, tokens of the second plurality of tokens 23, and replacement tokens 24 function similarly to each other, as described in detail above, especially with reference to FIGS. 3-4. But the different classes of tokens are minted at different steps of some methods of titling and transferring tokens, as described in detail below, especially with reference to FIGS. 6-7.

The system 50 further comprises at least one replacement-token user device 25. The replacement-token user device 25 is a user device similar to the first user device 16 and the second user device 17. The functionality of the replacement-token user device is described in detail below, especially with reference to FIG. 7.

FIG. 6 is a flowchart for an embodiment of a method 100 of titling and transferring tokens 11 associated with equitable title 6. The method 100 comprises a number of steps, as shown in FIG. 6. In describing the method 100, reference will be made to the elements described in detail above and depicted in FIGS. 1-5.

Step 101 is determining an assessment 19 of the amount of commodities 2 that are at the site 1.

Optional Step 102 is certificating the assessment 19. Certificating the assessment 19 results in a certification of the assessment 19. Optional Step 103 is obtaining an insurance instrument that insures the certification.

Step 104 is providing a blockchain-based transaction network 12.

Step 105 is minting a first plurality of tokens 11. In some embodiments, minting a first plurality of tokens 11 requires a multi-key authorization—with defined roles for trustees, regulators, and/or a third-party auditor or arbitrator.

Optional Step 110 is: not removing (or severing) the commodities 2 from the site 1. Specifically, Step 110 is: not removing (or severing) an economically significant amount of the commodities 2 from the site 1. It is not inconsistent with this Step 110 that small quantities of commodities 2 may be severed from the site 1 for the purpose of determining an assessment 19 of the amount of commodities 2 that are at the site 1, for example at Step 101—such as in drilled core samples, assay samples, or other samples constituting (for example) less than 1.0 percent (or alternatively less than 0.10 percent) of the commodities 2 at the site 1.

Optional Step 106 is, for each token 11, deeming each portion 21 of the assessment 19 to have been produced, wherein so deeming converts the equitable title 6 from an equitable title in realty to an equitable title in personalty. So deeming also coverts the legal title to the portion 21—held by the trust 3—from a legal title in realty to a legal title in personalty.

Step 107 is storing each token 11 on either the token server 13 or a user device 16, 17.

Step 108 is transferring at least one token 11 from the first user device 16 to the second user device 17. As described in detail above, especially with reference to FIGS. 3-4, this transfer causes a transfer of the associated equitable title 6. Such a transfer can be initiated: by the owner of the user device 16, 17 on which the token 11 is stored; by a governmental entity (e.g., pursuant to a court order, foreclosure, will, devise, intestate succession, conservatorship, to enforce a lien or judgment, etc.); or by a smart-contract mechanism whereby contingencies that occur operate to transfer tokens 11 and ownership from one user device 16, 17 to another.

In some embodiments, it is possible to transfer a token 11 from the first user device 16 to the second user device 17 directly, in a peer-to-peer transaction without connection to the internet. In such embodiments, the first user device 16 and the second user device 17 would, the next time they connect to the internet, update the blockchain-based transaction network 12 and validate the transaction.

Optional Step 109 is, on an occurrence of a triggering event, minting a second plurality of tokens 23. One function of a stablecoin can be to provide a mechanism to minimize price volatility in a digital asset. In the event of an increase in demand for a stablecoin, provision can be made to provide an additional supply of tokens. This increase in demand may result from growth in the overall adoption of cryptocurrencies or from an increase in the demand for the stablecoin for use in managing portfolios of digital assets. In the case of non-fiat—pegged stablecoins, an increase in demand can result from the desire for its use as a store of value or hedge against devaluation of fiat-denominated assets.

Fulfillment of short-term increases in supply can be provided from liquidity reserves or from a process of minting additional tokens (as in Step 109). The process of minting additional tokens may be triggered automatically based upon pre-arranged agreements and utilizing automated processes. For example, the triggering event could be when a threshold of demand growth is reached, or when a level of liquidity reserves is reached. The minting process at Step 109 can be initiated either manually or automatically (e.g., by means of a smart contract). In some embodiments, Step 109 further comprises: (1) transferring the ownership of an additional allocation of commodities 2 from a participating reserve property (e.g., a site 1) to the minting entity; and (2) tokens 23 being minted corresponding to the value of the additional reserves. Participating exchanges and liquidity-providers then purchase these newly minted tokens 23 and the funds paid by such parties are transferred to the participating property owners or beneficiaries 4. In some embodiments this minting process occurs seamlessly and immediately, thus providing a level of flexibility to expand liquidity for a stablecoin in response to market conditions. This ability to rapidly expand liquidity may operate either on an incremental basis—supporting supply expansion by single-digit percentages over time-scales of days to months—or on a massive scale.

FIG. 7 is a flowchart for an embodiment of a method 200 of titling and transferring tokens 11 associated with equitable title 6. In addition to the steps described in detail above with reference to FIG. 7, the method 200 further comprises additional steps.

Step 201 is, while a token 11 is stored on the second user device 17, transmitting—either at predetermined intervals, or at the time of a transaction, or both—the existence signal 22 from the second user device 17 to the token server 13.

Step 202 is, after a predetermined duration during which the token server 13 has not received the existence signal 22 associated with the token 11, minting a replacement token 24. The replacement token 24 “replaces” the token 11, which might no longer exist when the token server has not received the associated existence signal 22 during a predetermined duration. The token server 13 mints the replacement token 24 such that: the replacement token 24 is associated with the same equitable title 6 as was the token 11; the replacement token 24 is a store of value of the equitable title 6; the replacement token 24 is a medium of exchange of the equitable title 6; and the replacement token 24 is a unit of account of the equitable title 6. The replacement token 24 has the same properties and functionalities as do the tokens of the first plurality of tokens 11 or of the second plurality of tokens 23.

Step 203 is storing the replacement token 24 on the replacement-token user device 25. (If the owner of the second user device 17 had previously reported having lost the token 11—e.g., through accident, malfunction, or carelessness—the replacement-token user device 25 can be the second user device 17.) In optional Step 205, tokens 11 are compared to ensure that no duplicates for the same portion 20 of the commodities 2 or portion 21 of the assessment 19 are in existence. Alternatively or in addition to the duplicate checker 30, in optional Step 206, if a new replacement token 24 is minted, then a destructor 31 on the token server 13 alters the token server 13 to make the replaced token 11 inert. Alternatively or in addition to the duplicate checker 30 and the destructor 31, in optional Step 207, a list of replaced tokens may be stored in a dead-token repository 32. If a dead-token repository 32 is used, the tokens listed therein may be deemed to have escheated to a governmental entity (e.g., a State). (By way of illustration, unclaimed tokens representing interests in commodities in a site in California might escheat to the unclaimed-property department of California.) In such embodiments, the escheatment process can help ensure that tokens—once minted—ultimately stay in circulation by helping to prevent loss through accident or carelessness. (Many governments already have procedures for recovering unclaimed property, at least for a given period of time.)

Step 204 is transferring the replacement token 24 from the replacement-token user device 25 to another user device 16, 17.

A method of titling and transferring tokens 11 with equitable title 6 may include steps or other elements from any combination of the methods described in detail above especially with reference to FIGS. 6-7. Rather than specifically describing each combination, method 100 and method 200 are described for clarity and brevity as exemplary embodiments of a method. In particular, the optional steps of method 100 are not depicted with method 200 in FIG. 7—this is strictly for clarity and is not intended to preclude any steps of any method disclosed herein from being included in any other method that is disclosed herein of titling and transferring tokens with equitable title.

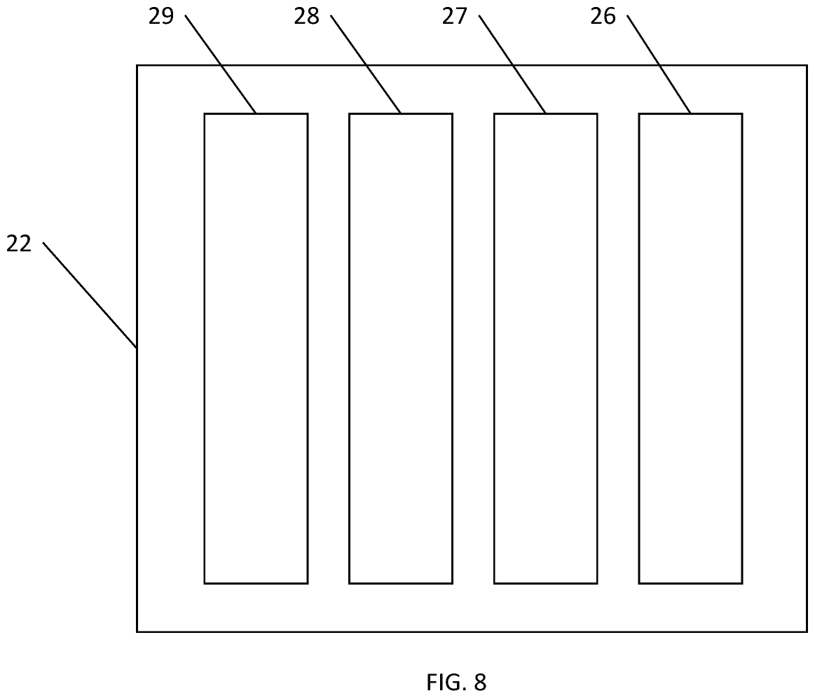

FIG. 8 is a schematic diagram of an embodiment of an existence signal 22. The existence signal comprises a token identifier 26, a user-device identifier 27, an owner identifier 28, and a transaction flag 29. The token identifier 26 uniquely associates the existence signal 22 with a specific token 11 (see FIG. 3). The user-device identifier 27 uniquely associates the existence signal 22 with a specific user device 16, 17 (see FIG. 3) on which the token 11 is stored. The owner identifier uniquely associates the existence signal 22 with the owner of the user device 16, 17 (see FIG. 3) on which the token 11 is stored. The transaction flag 29 is a portion of the existence signal 22 that indicates whether the existence signal 22 is being sent at a predetermined interval or, instead, on the occurrence of a transaction. If the transaction flag 29 indicates that a transaction has occurred, the new user-device, owner, and (optionally) transaction history are stored on the token server 23. In some embodiments, the existence signal 22 may be generated and lodged with the token server 13 on each and every transfer of a token 11. In such embodiments, any subsequent loss of a token 11 will have, on the token server 13, an existence-signal—and—ownership record associated with the token 11.

While the foregoing specification has described specific embodiments of this invention and many details have been put forth for the purpose of illustration or example, it will be apparent to one skilled in the art that the invention is susceptible to additional embodiments and that certain of the details described herein can be varied considerably without departing from the basic principles of the invention.

What is claimed is:

1. A method for titling and trading alternative reserves of physical commodities of a site, wherein the commodities are owned by a trust having at least one beneficiary, and wherein the trust holds legal title to the commodities and each beneficiary holds a share of equitable title to the commodities; the method comprising:
determining an assessment of an amount of commodities that are at the site;
certificating the assessment;
providing a blockchain-based transaction network comprising:
at least two user devices, and
a token server comprising a processor and a cache wherein the cache is for reducing memory latency and access time;
minting a first plurality of tokens,
wherein each token is associated with an equitable title to a portion of the assessment,
wherein each token is a store of a value of the associated equitable title, and
wherein each token is a medium of exchange of the associated equitable title;
storing each token on a user device; and
transferring at least one token from a first user device to a second user device,
wherein transferring the token effects a transfer of the associated equitable title.

2. The method of claim 1, wherein the commodities include deposits of one or more of the following: gold, silver, nickel, platinum, palladium, or copper.

3. The method of claim 1, wherein the trust is one or more of the following: an equity real estate investment trust (“REIT”), or a statutory trust.

4. The method of claim 1, further comprising not removing the commodities from the site.

5. The method of claim 1:
wherein certificating the assessment results in a certification of the assessment; and
wherein the method further comprises obtaining an insurance instrument that insures the certification.

6. The method of claim 1, further comprising, for each token, deeming each portion of the assessment to have been produced,
wherein so deeming converts the equitable title to the portion from an equitable title in realty to an equitable title in personalty.

7. The method of claim 6, wherein so deeming converts a legal title to the portion from a legal title in realty to a legal title in personalty.

8. The method of claim 1, wherein the first plurality of tokens is associated with equitable title to less than all of the assessment.

9. The method of claim 8, further comprising: on an occurrence of a triggering event, minting a second plurality of tokens.

10. The method of claim 1, wherein the blockchain-based transaction network comprises at least one replacement-token user device, the method further comprising:
while the token is stored on the second user device, transmitting at predetermined intervals an existence signal from the second user device to the token server,
wherein the existence signal is uniquely associated with the token; and
after a predetermined duration during which the token server has not received the existence signal associated with the token, minting a replacement token,
wherein the replacement token is associated with the equitable title to the portion,
wherein the replacement token is a store of a value of the associated equitable title, and
wherein the replacement token is a medium of exchange of the associated equitable title; and
storing the replacement token on a first replacement-token user device.

11. The method of claim 10, further comprising transferring the replacement token from the first replacement-token user device to a second replacement-token user device,
wherein transferring the replacement token effects a transfer of the associated equitable title.

12. A system for titling and trading alternative reserves of physical commodities of a site, wherein the commodities are owned by a trust having at least one beneficiary, and wherein the trust holds legal title to the commodities and each beneficiary holds a share of equitable title to the commodities; the system comprising:
a blockchain-based transaction network comprising:
a token server comprising a processor and a cache wherein the cache is for reducing memory latency and access time, and
at least two user devices,
wherein each user device is communicatively coupled to the token server, and
wherein each user device is capable of being communicatively coupled to each other user device;
a record of a certificated assessment of an amount of commodities that are at the site,
wherein the record is stored on the token server;
a first plurality of tokens,
wherein each token is minted by the token server,
wherein each token is associated with an equitable title to a portion of the assessment,
wherein each token is a store of a value of the associated equitable title,
wherein each token is a medium of exchange of the associated equitable title, and
wherein each token is capable of being stored on a user device;
wherein at least one token may be transferred from a first user device to a second user device by a communicative coupling between the first user device and the second user device,
wherein transferring the token effects a transfer of the associated equitable title.

13. The system of claim 12, wherein the commodities include deposits of one or more of the following: gold, silver, nickel, platinum, palladium, or copper.

14. The system of claim 12, wherein the trust is one or more of the following: an equity real estate investment trust (“REIT”), or a statutory trust.

15. The system of claim 12, wherein the first plurality of tokens is associated with equitable title to less than all of the assessment.

16. The system of claim 15, further comprising a second plurality of tokens,
wherein each of the second plurality of tokens is minted by the token server on the occurrence of a triggering event.

17. The system of claim 12, wherein each user device is adapted to transmit at predetermined intervals at least one existence signal from the user device to the token server.

18. The system of claim 17, wherein each existence signal is uniquely associated with a token stored on the user device.

19. The system of claim 18, wherein the token server is adapted to mint a replacement token when the token server does not receive an existence signal from the user device after a predetermined duration,
wherein the replacement token is associated with the equitable title to the portion,
wherein the replacement token is a store of a value of the associated equitable title, and
wherein the replacement token is a medium of exchange of the associated equitable title.

20. The system of claim 19, wherein transferring the replacement token effects a transfer of the associated equitable title.
